(19) United States
(12) Patent Application Publication
(10) Pub. No.: US 2024/0012731 A1
(43) Pub. Date: Jan. 11, 2024

(54) DETECTING EXCEPTIONAL ACTIVITY DURING DATA STREAM GENERATION

(71) Applicant: International Business Machines Corporation, Armonk, NY (US)

(72) Inventors: Benjamin P. Segal, Hyde Park, NY (US); Donald William Schmidt, Stone Ridge, NY (US); Erik Richter Altman, Danbury, CT (US)

(21) Appl. No.: 17/811,662

(22) Filed: Jul. 11, 2022

(51) Int. Cl. G06F 11/30; G06F 11/34; G06F 11/07

(52) U.S. Cl. CPC G06F 11/3082; G06F 11/3414; G06F 11/3428; G06F 11/079

(57) ABSTRACT

A computer-implemented method for detecting anomalies in computing systems includes measuring activity metrics associated with accessing resources of the system by several users. Further, condensed diagnostic data is generated by grouping the users into buckets based on bucket and user attributes, and aggregating the activity metrics across all users in each bucket. Bucket contents are recorded during system's use, during which, analytic embedded data is generated for anomaly detection. The generating includes, for each bucket, capturing the activity metrics for an exceptional user in each bucket without aggregation at a next time interval.

### BACKGROUND

The present invention relates to computer servers, particularly to detect anomalous activity in computer servers by dynamically identifying potential data streams that can be embedded, at data generation itself, with specific data for facilitating anomaly detection and/or accurate decision making.

Operating systems (e.g., z/OS) provide controls to share finite hardware resources amongst client services. A workload consists of 1 or more jobs performing computing for similar client services. When multiple workloads are executing in parallel on the same operating system, a component (e.g., Workload Manager (WLM) on z/OS) provides controls to define attributes for each workload, such as an important level and a goal (e.g., response time). At regular intervals (e.g., every 10 s), this component assesses the results of each workload and may change the scheduler priority attribute of each workload, so most important workloads achieve their goals. Work represents the aggregate computing performed across all workloads.

For images serving multiple (e.g., double digits) workloads, transient performance problem diagnosis requires identifying problematic workload(s), defining the root cause, and recommending corrective action. A performance analyst uses visual analytics to graphically visualize activity in the form of metrics (e.g., central processing unit (CPU) execution time, CPU efficiency, CPU delay, serialization contention, etc.) against time for all work to define normal and anomalous activity. Detailed visual analytics against each workload can be overwhelming to an analyst and require significant computing resources.

### SUMMARY

A computer-implemented method for detecting anomalies in computing systems includes measuring activity metrics associated with accessing resources of the system by several users. Further, condensed diagnostic data is generated by grouping the users into buckets based on bucket and user attributes, and aggregating the activity metrics across all users in each bucket. Bucket contents are recorded during system's use, during which, analytic embedded data is generated for anomaly detection. The generating includes, for each bucket, capturing the activity metrics for an exceptional user in each bucket without aggregation at a next time interval.

A system includes a memory and one or more processing units that perform a method for detecting anomalies in computing systems includes measuring activity metrics associated with accessing resources of the system by several users. Further, condensed diagnostic data is generated by grouping the users into buckets based on bucket and user attributes, and aggregating the activity metrics across all users in each bucket. Bucket contents are recorded during system's use, during which, analytic embedded data is generated for anomaly detection. The generating includes, for each bucket, capturing the activity metrics for an exceptional user in each bucket without aggregation at a next time interval.

A computer program product includes a memory device with computer-executable instructions therein, the instructions when executed by a processing unit perform a method for detecting anomalies in computing systems includes measuring activity metrics associated with accessing resources of the system by several users. Further, condensed diagnostic data is generated by grouping the users into buckets based on bucket and user attributes, and aggregating the activity metrics across all users in each bucket. Bucket contents are recorded during system's use, during which, analytic embedded data is generated for anomaly detection. The generating includes, for each bucket, capturing the activity metrics for an exceptional user in each bucket without aggregation at a next time interval.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings.

FIG. 1 depicts a block diagram of a system that collects resource and activity metrics to create micro-trends according to one or more embodiments of the present invention.

FIG. 2 depicts a flowchart for aggregating, grouping, and summarizing user activity to generate human-consumable high-frequency, concise, and context-rich data for micro-trends according to one or more embodiments of the present invention.

FIG. 3 depicts a flowchart of an example method for transforming human-consumable high-frequency, concise, and context-rich data into micro-trends and using micro-trends for workload diagnosis according to one or more embodiments of the present invention.

FIG. 4 depicts a flowchart for an example method for collecting metrics, generating data, and transforming data into micro-trends for establishing consumed resource to consumer relationships according to one or more embodiments of the present invention.

FIG. 5 depicts a flowchart of an example method to generate micro-trend data for machine learning according to one or more embodiments of the present invention.

FIG. 6 depicts a flowchart of a method for anomaly detection according to one or more embodiments of the present invention.

FIG. 7 is a depiction of anomaly detection in an example scenario of data set (i.e., file) access according to one or more embodiments of the present invention.

FIG. 8 provides a visual depiction of an entropy-based anomaly detection example.

FIG. 9 provides a block diagram of an example system according to one or more embodiments of the present invention.

FIG. 10 depicts a computing system in accordance with one or more embodiments of the present invention.

FIG. 11 depicts a cloud computing environment according to one or more embodiments of the present invention.

FIG. 12 depicts abstraction model layers according to one or more embodiments of the present invention.

The diagrams depicted herein are illustrative. There can be many variations to the diagrams or the operations described therein without departing from the spirit of the invention. For instance, the actions can be performed in a differing order, or actions can be added, deleted, or modified. Also, the term “coupled” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

Embodiments of the invention described herein address technical challenges in computing technology, particularly in fields where multiple data sources (producers) generate respective streams of data, and the data has to be analyzed to identify anomalies. Alternatively, or in addition, embodiments of the present invention also facilitate accurate decision making. At times decision making requires correlated and concentrated high-value data to deal with the extreme number of variables (hundreds, thousands, etc.) that are to be considered. Bulk streams of low-value detail data increase the computing costs required to generate, transmit, and analyze such data. One or more embodiments of the present invention use embedded analytics to include data concentrating sensors in the mainline path operations to share data analysis responsibilities between the data producers and the analytics engine. The additional costs incurred by not producing and consuming ideal purpose-built data, significantly impede the ability to cost effectively perform timely and accurate decision making.

For example, computer servers, such as large-scale server environments, face such technical challenges because of the complexity of software interactions, when processing arbitrarily large numbers of resources, when analyzing orders of magnitude of generated “log data,” and several other scenarios. In any such scenario, patterns of operation (legitimately) change over time and can be periodic or chaotic. Detecting anomalies in the data generated can require “domain knowledge” to “understand” the true anomaly. Further, detecting the anomalies can be operationally expensive (processor-intensive, memory-intensive, impacts to service level agreements (SLA)), particularly to monitor “everything,” i.e., each data element that is generated and consumed. Presently, existing solutions use improved algorithms (e.g., sampling, filtering, etc.) and artificial intelligence, for example, to reduce the data being analyzed or to reduce the patterns to be analyzed. However, such technical solutions are limited by the quality of data.

It should be noted that while embodiments of the present invention are described using the context of computer servers and operations associated with such computer servers, other embodiments of the present invention can be applied in other technical fields with the growing volume of raw data. For example, the proliferation of machine data is being accelerated by the expanding use of internet-of-things (IoT), with some reports indicating that there will be more than 41 billion connected IoT devices, generating an estimated 79.4 zettabytes (ZB) of data in the year 2025. Such IoT devices can be found not only in household consumer settings but also in industrial settings, such as factories, warehouses, supply-chain routes, etc. Further, advances and proliferation of communication networks have increased the use of streaming media, vehicle-to-vehicle communications, e-commerce, and several other use cases where large amounts of electronic/digital data are being generated and consumed. It is understood that the above are illustrative uses and that embodiments of the present invention are not limited to only such uses but rather can be applicable in several other scenarios.

With the increasing trend in the use of digital data, cyberattacks have also increased in frequency. Accordingly, security analytics is critical for the success of uses of digital data, such as those mentioned herein. As organizations become more data-driven, they have scaled their analytics capabilities using automation. Artificial intelligence is being used to automate processes from recommendations and bidding to pattern detection and anomaly detection. Generally, the presently available techniques for anomaly detection rely on analyzing unidimensional time series. Such techniques are limited because the data that is generated, especially with the proliferation of computer servers and communication devices, is multi-dimensional. For instance, in microservices-based architectures (which routinely comprise thousands of microservices), analyzing data of individual microservices would, most likely, mask key insights.

Technical challenges described herein are addressed by one or more embodiments of the present invention by facilitating embedding analytics into the data generation over time-series intervals. Accordingly, data generation is improved to facilitate the detection of anomalies, which can be at the data generation and/or the data consumption. In some embodiments of the present invention, the improved data generation builds upon operating system level awareness, and exploiting standardized data collection points, grouping arbitrarily long list of resources (e.g., files) into resource groups, capturing exploitation patterns of consumers acting on any group over the finite time interval, determining resource groups being “offended” by consumers, and identifying offending consumer(s) for those resource group(s) over next time interval to capture the specific set of resources.

Further, embodiments of the present invention facilitate using anomaly detection to determine relationships that, in turn, facilitate reducing time to detection and remediation. Additionally, embodiments of the present invention group anomalies associated with separate producers/consumers so that a single alert/notification can be provided collectively for that entire group instead of multiple alerts—for example, one for each anomaly in a group.

Embodiments of the present invention can accordingly reduce the need to monitor everything, for example, each and every metric generated, each and every data stream, etc. Rather, embodiments of the present invention facilitate automatically determining what exceptional activity to focus on based on aggregated, summarized data. Further, embodiments of the present invention can detect the anomalies dynamically, without any up-front policy definitions. Embodiments of the present invention facilitate using minimum processor and memory resources during anomaly detection. Further, embodiments of the present invention ensure that the resources are used for monitoring exceptional behavior and trends captured and comparing them over time, rather than monitoring “uninteresting” behavior, which is ignored (automatically filtered).

Additionally, embodiments of the present invention facilitate correlating individual consumers directly to individual resources being acted upon. Accordingly, embodiments of the present invention are based on using exceptionalism-enriched data streams.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprises,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The term “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with the measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Assessing the performance of workloads on computing systems can be an important part of the testing and day-to-day operation of workloads. Traditionally such assessments are accomplished through workload performance instrumentation that includes a workload and component summary collected at a long interval (e.g., 15 minutes). Performance analysts begin by assessing the overall workload and component summary. When the overall results are unexpected, a performance problem occurs during most of the long interval (e.g., the problem occurred for 10 out of 15 minutes), and the analyst knows which components require further investigation. When the overall results look good, there can be transient performance problems occurring for a small part of the interval (e.g., 3 minutes) that go unnoticed because they are lost in averages across the interval. For example, 90% CPU utilization for a long interval (e.g., 15 minutes) can be achieved through the workload consistently running at 90% CPU utilization or the workload having periods at 70% CPU utilization and other periods at 100% CPU utilization. Using existing techniques, performance analysts cannot see the difference. Gathering the workload and component summary has high compute costs at the interval end, so collecting the data at a shorter interval (e.g., 1 minute) can incur unacceptable compute costs and, in some situations, distort the underlying performance.

A computer server (“server”) makes finite hardware resources available to multiple applications. The server consists of many stack layers (e.g., middleware, operating system, hypervisor, and hardware). Every stack layer contains components (single to double digits) that manage resources (single digits to thousands) that are virtualized to the applications and consequently to the users of those applications. The workload consists of stack layers, components, and user requests. The workload context consists of component activities and resources and their interdependencies and interactions. As the arrival pattern changes, the workload context changes.

A workload performance problem typically describes a problem symptom like a slow/erratic response time or high resource contention. The overall workload and component summary are investigated, and the problem is sent to the component that is most likely the problem source for further diagnosis. A component expert generally begins with first failure data capture that includes a multi-minute (e.g., 15 minutes) component summary of activity (e.g., requests, response times) to identify normal and anomalous results. If no anomalous results are found, the component is not obviously involved, and the problem is sent to a different component expert. When an individual component discovers anomalous results or all components have no anomalous results, in summary, component details (e.g., all component activity records) must be investigated. Each component has its own controls to capture component details due to the high CPU overheads associated with collecting component details. Collecting component details requires recreating the problem. If the component details across all suspected components do not contain information about the anomalous results, new traces and diagnostics must be pursued. With the necessary component details, an expert will be able to define the problem or route the problem to another expert to investigate further. Recreating the problem to collect new data, transform data, analyze data, engage new experts, collect additional data, and correlate data across components increases the time required to define the workload context and ultimately define the underlying problem.

With existing technologies, an advanced performance analyst can apply machine learning to build a model using detailed training data. Machine learning training requires significant compute and memory resources to transform data, identify and consider important data, and ignore the noise. With a model in place, test data can be scored to detect and correlate anomalies. An advanced performance analyst then defines a problem that fits the anomalies from machine learning. A problem definition enables a performance analyst to take action against a workload component or resource to address the problem.

With existing technologies, workload components cannot produce high-frequency, summary data for an acceptable CPU cost with current support and procedures. Using existing techniques, workload components can collect summary data for long intervals (e.g., 15 minutes) at an acceptable compute CPU cost. Summary data cannot be collected at a short interval (e.g., less than 1 minute) because of the unacceptable increase in CPU cost and can distort the problem. With existing techniques, workload component details can be collected for specific problems but incur unacceptable CPU costs when regularly collected.

The present invention provides an orthogonal approach to generating synchronized, standardized, and summarized data for immediate analysis. This smarter data can be collected at a human-consumable high-frequency (e.g., greater than one second) for an undetectable CPU cost. A lightweight analytics engine can transform this smarter data into component activity and resource micro-trends and correlate micro-trends to reveal workload component activity and resource interdependencies and interactions with cause and victim peers. The whole process, from the smarter data generation to the analysis, focuses on summarizing data and thereby reducing noise, which enables an analyst to quickly transform data into insights.

Embodiments of the present invention facilitate diagnosing workload performance problems by collecting activity (e.g., CPU execution time) at a human-consumable high-frequency (e.g., greater than one second), establishing the activity normal baseline (e.g., mean), identifying baseline deviations (e.g., deviating 10% above or below the baseline), and temporally correlating baseline deviations. A micro-trend is a short-duration (e.g., one or more high-frequency intervals) deviation from the baseline. Further, every micro-trend contains a peak for every baseline deviation period above the baseline or a valley for every baseline period below the baseline. Micro-trend peak and valley correlations are used to identify the cause and victim peers amongst component activities and resources across the stack.

One or more embodiments of the present invention address technical challenges and facilitate an analyst to quickly investigate component data to identify normal and anomalous activity and determine the workload context. Accordingly, one or more embodiments of the present invention facilitate decreasing the time required to determine the involved components, their interdependencies, their interactions, and how they are being affected by the underlying performance problem. One or more embodiments of the present invention are rooted in computing technology, particularly diagnosing workload performance problems in computer servers. Further, one or more embodiments of the present invention improve existing solutions to the technical challenge in computing technology by significantly reducing the time required to identify normal and anomalous activity and determine the workload context.

Embodiments of the present invention facilitate diagnosing workload performance problems by using time-synchronized cross-stack micro-trend data generation.

Performance problems do not occur in a vacuum. Their ripple effects permeate through the workload. One or more embodiments of the present invention use such component ripple effects to detect clues to define the underlying problem. Component ripple effects can have short or long durations with impacts ranging from none, to subtle, to significant. Detecting such component ripples requires high-frequency, synchronized, standardized, and summarized data generation. Accordingly, micro-trends make subtle component ripple effects for transient durations detectable and hence can be used for diagnosing previously undetectable workload performance problems.

One or more embodiments of the present invention facilitate generating micro-trends with a substantial reduction in CPU costs. Using one or more embodiments of the present invention, because of low overhead, a server can aggregate always-on cross-stack high-frequency activity metrics that capture the arrival pattern effects on the workload context. An analytics engine transforms activity metrics into micro-trends. Correlating micro-trends cast a wide net to catch ripple effects across the entire workload and ensure performance first failure data capture is available whenever a performance problem is reported.

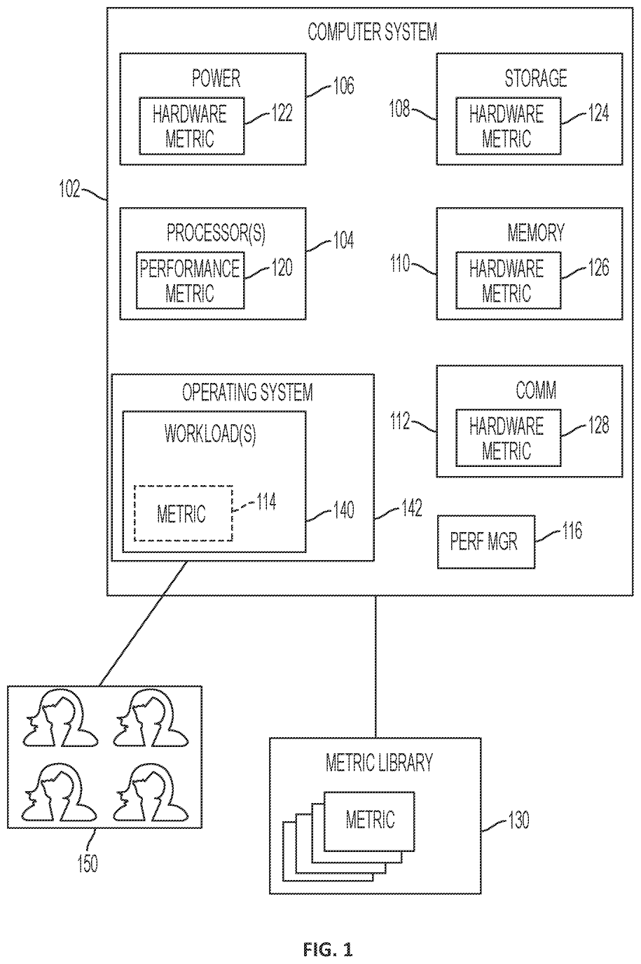

FIG. 1 depicts a block diagram of a system that collects metrics to create micro-trends according to one or more embodiments of the present invention. In some embodiments, system 100 includes a computer system 102, performance manager 116, and metric library 130. Computer system 102 may include processors 104, memory 110, and power subsystem 106, among other components. Computer system 102 may optionally include storage subsystem 108 and communication subsystem 112. The computer system 102 can run multiple operating systems 142 (e.g., z/OS) that run multiple workloads 140 (e.g., On-Line Transaction Processing [OLTP] and batch) to satisfy requests from multiple users 150. In some operating systems (e.g., z/OS), a user instance (150) is embodied in a job (e.g., a work unit for the operating system to complete).

Processors 104 may include one or more processors, including processors with multiple cores, multiple nodes, and/or processors that implement multi-threading. In some embodiments, processors 104 may include simultaneous multi-threaded processor cores. Processors 104 may maintain performance metrics 120 that may include various types of data that indicate or can be used to indicate various performance aspects of processors 104. Performance metrics 120 may include counters for various events that take place on the processors or on individual processor cores on a processor. For example, a processor may have architected registers that maintain counts of instructions, floating-point operations, integer operations, on-processor cache hits, misses, pipeline stalls, bus delays, etc. Additionally, time may be a performance metric. Registers or other data locations or functions that maintain a time value may be used as a performance metric 120 in some embodiments.

Memory 110 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.). A memory controller for memory 110 may maintain performance metrics 126 that may include various types of data that indicate or can be used to derive indicators of memory performance. For example, memory performance metrics 126 may include a counter for the number of memory accesses, type of accesses (e.g., read or write access), cache hits, cache misses, etc.

Power subsystem 106 provides and regulates power to the various components of computer system 102. Power subsystem 106 may maintain performance metrics 122 that comprise voltage levels for various rails of one or more power supplies in power subsystem 106.

Storage subsystem 108, when present, provides persistent storage for computer system 102. Such storage can include hard disks, optical storage devices, magnetic storage devices, solid-state drives, or any suitable combination of the foregoing. Storage subsystem 108 may maintain performance metrics 124 that may include counts of read or write accesses, or timing information related to reads, writes, and seeks.

Communication subsystem 112, when present, provides network communication functions for computer system 102. Communication subsystem 112 may maintain performance metrics 128 that may include counts of packets transmitted and received and other data regarding network communications. In some embodiments, communication subsystem 112 may include a network interface (e.g., an ATM interface, an Ethernet interface, a Frame Relay interface, SONET interface, wireless interface, etc.)

The computer system 102 contains operating systems (142) that can be configured to process workloads 140. A workload 140 is a set of tasks interacting to complete requests from users 150. An operating system 142 maintains performance metrics 114 for each user about its communication activity (e.g., data size) and resource use (e.g., time using network adapter to send/receive packets from rom communication subsystem 112). In some embodiments, a performance manager 116 facilitates tracking performance metrics (e.g., read and write accesses from memory subsystem 126) and updating workload and user metrics. Different workloads may have different characteristics. For example, OLTP (On-Line Transaction Processing) workloads typically involve many data entry or retrieval requests that involve many short database interactions. Data mining workloads, on the other hand, have few interactions with users but more complicated and lengthy database interactions. Different types of workloads 140 may have different impacts on the activities and resources of computer system 102.

In one or more embodiments of the present invention, a lightweight method includes an instruction sequence to aggregate the metrics described above that is used during the mainline operation of the workload. In one or more examples, the lightweight method is always running during mainline processing to aggregate metrics about computer system resource 102 use and the workload activity 140.

The performance manager 116 calculates metric deltas from the components of the computer system 102, including the workload 140 at periodic synchronized intervals. The periodic synchronized interval is at a human-consumable high-frequency that is greater than one second. The metrics for each component are generated in a continuous and always-on manner as described herein. In one or more embodiments of the present invention, an administrator can switch off the data generation via the performance manager 116. Data generation is based on a synchronized interval across the whole computer system 102. Once different component metrics are using different intervals, correlations are much less viable. Consequently, the metric deltas are computed at the synchronized human-consumable high-frequency interval (e.g., greater than one second) across all components.

The metric library 130 represents the collection of metrics 120, 122, 124, 126, 128 that the performance manager 116 produced across all aspects of the computer system 102. The metric library 130 may be part of computer system 102, or it may be maintained on a separate system that is available to the computer system 102.

In some embodiments, the metrics aggregated and captured are customized for particular hardware implementation and/or for the particular type of workload 140. For example, for a particular workload 140, the metrics that are aggregated and captured only include hardware metrics 120 for the used family of processors and memory subsystems.

The performance manager 116 further transforms the captured metrics into concise summaries using multiple levels of aggregation. Every aggregation level removes one or more details and further refines the data. The last aggregation level yields the context-rich and concise data required for micro-trends that can be used by an expert to define previously unseen workload performance problems.

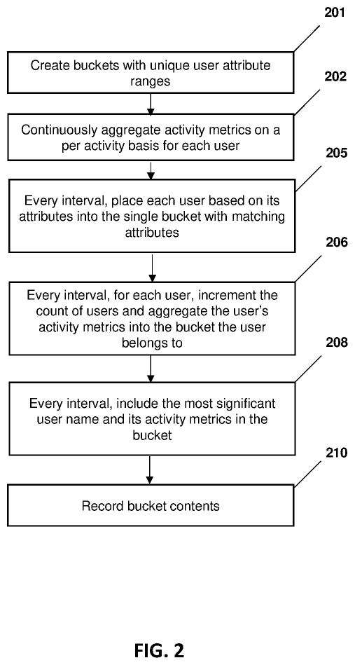

FIG. 2 depicts a flowchart for aggregating, grouping, and summarizing metrics to generate human-consumable high-frequency, concise, and context-rich data for micro-trends according to one or more embodiments of the present invention. To summarize similar users 150, every stack layer creates a small number of buckets (e.g., less than 30) with unique user attribute ranges (201) to standardize how each layer distributes its users 150 across buckets. For example, the operating system layer can choose the number of buckets based on four user priority attributes (e.g., critical, high, low, discretionary) and four user size attributes (e.g., large, medium, small, tiny) which yields 16 buckets (e.g., critical+large, critical+medium, . . . discretionary+small, discretionary+tiny). Similarly, the hypervisor layer can choose a number of buckets based on its users (e.g., operating systems), size (e.g., large, medium, small, tiny), and type (e.g., z/OS, z/TPF, z/Linux, z/VM, etc.). It is understood that the above are examples of dividing the users 150 into buckets and that one or more embodiments of the present invention can use different bucket attributes and values and ranges to achieve the same effect. Furthermore, every component inherits buckets and bucket attribute ranges from its stack layer. For example, the scheduler component of the operating system 142 inherits its buckets from the operating system 142 (e.g., critical+large, critical+medium, discretionary+small, discretionary+tiny) and their attribute ranges. In another example, the scheduler component of the hypervisor inherits the hypervisor buckets and attribute ranges (e.g., large+z/OS, medium+z/OS tiny+z/Linux, tiny+z/VM).

Next, every component continuously aggregates activity metrics (e.g., number of requests, response times) on a per activity basis for each user 150 (202). This is the first level of aggregation. For example, the performance manager 116 aggregates CPU activity metrics (e.g., CPU requests [dispatches], CPU delay time, and CPU use time) from hardware metrics (120) and, in some embodiments of the present invention, the operating system metrics (142). The operating system 142 or performance manager 116 aggregates the results locally for every user 150.

Consider a computer system that has 30 or more users 150. The CPU activity metrics for every user 150 can overwhelm a human expert that is investigating such activity. Moreover, in typical scenarios, the number of users is even larger (in hundreds, if not thousands). A context-rich and concise activity summary for buckets of users 150 with similar activity can facilitate the human expert to analyze the data and diagnose the workload problem more efficiently.

Then for every human-consumable high-frequency interval (e.g., greater than one second), the performance manager (116) places each user based on its attributes into the single bucket with matching attributes (205) and, for each user, increments the count of users and aggregate the user's activity metrics into the bucket the user belongs to (206). During this second level of aggregation, the most significant user name and its activity metrics are included in the bucket (208). In this embodiment, there is a single most significant user name and activity metrics, but other embodiments may include multiple significant users (e.g., low single digits). In this embodiment, the performance manager 116 performs the actions required for block 206 and 208. As shown in block 210, the performance manager 116 then records bucket contents for analysis. In some embodiments, the performance manager 116 may output visual analytics to an operatively connected output device.

Grouping users into a small number of buckets and aggregating user activity into buckets enables performance analysts to quickly detect user activity changes across all users 150 in the bucket. Furthermore, with the most significant user and its corresponding activity in each bucket, performance analysts can quantify how much of the bucket activity changes were attributable to the most significant user 150. Performance analysts can use a most significant user to determine whether one or multiple users are driving the majority of the bucket activity changes. When multiple users are driving bucket activity changes, performance analysts know other users are causing smaller impacts.

Further, in the same interval, low-level activities are generalized into higher-level user constructs. For example, low-level activity metrics that are associated with a specific user (150) are generalized by aggregating them into a bucket (206). When there is no specific user (e.g., for operating system overhead), the activity metrics are associated with the operating system (142), which may be treated as a special user (150) in its own bucket or like a regular user (150) and aggregated into an existing bucket (206). In either case, the data aggregation is performed continuously.

Over multiple intervals, bucket activity metrics exhibit normal and anomalous periods. Bucket activity metrics enable establishing normal baseline periods and baseline deviation periods as anomalous for a group of similar users. A micro-trend is a short-duration (e.g., one or more high-frequency intervals) deviation period from the baseline. Every micro-trend above the baseline has a peak (e.g., a maximum value) and every micro-trend below the baseline has a valley (e.g., a minimum value). When activity metric peaks or valleys occur in buckets across multiple components and users, those activities are correlated between cause and victim peers. Micro-trend correlations can reveal cross-stack interdependencies and relationships between buckets, most significant users, and activities because the same synchronized cross-stack interval is used to accumulate activity metrics across all components in the stack

For any component across the hardware or software stack, micro-trend data generation delivers a cross-stack summary of vital statistics that identify the affected buckets, users, and activities of an ailing workload.

According to embodiments of the present invention, a performance analyst can much more quickly identify which workload component(s) and which user(s) are cause and victim peers in a transient performance problem.

One or more embodiments of the present invention measure per user activity metrics for one or more activities independently from other activities. Aggregating user activity metrics into buckets improves the efficiency with which an analyst can diagnose workload performance problems. For example, if a component provides multiple services, the above technique can be applied to track only the relevant metrics for a particular service (e.g., the number of times the service, like allocate memory, was called) for each user. As a second example, consider CPU use. The computer system 102 can have a lot of CPUs, but which CPU a user operation actually ran on really does not matter; what matters is the CPU time used. So above techniques facilitate tracking the amount of CPU time used for each user. It is understood that CPU time (or processor usage, or processor time) is just one metric that can apply micro-trends. In a similar manner, and in conjunction, in one or more embodiments of the present invention, other metrics such as the number of requests, response time, accesses, and others for a particular computing resource can apply micro-trends.

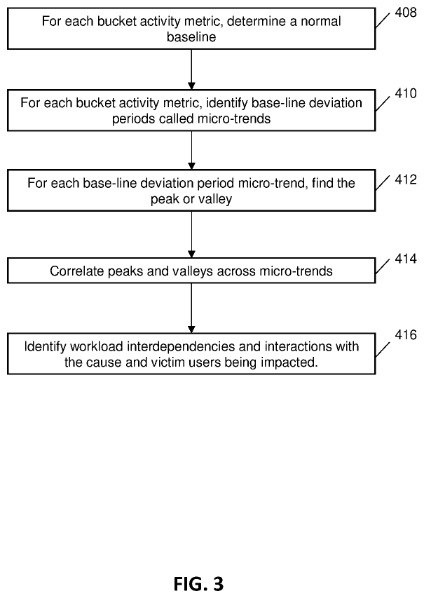

FIG. 3 depicts a flowchart of an example method for transforming human-consumable high-frequency, concise, and context-rich data into micro-trends and using micro-trends for workload diagnosis according to one or more embodiments of the present invention. The method includes using the performance manager 116 and metrics library 130, creating buckets with unique user attribute ranges (201), continuously aggregating activity metrics on a per activity basis for each user (202), placing each user based on its user attributes into the bucket with matching attributes (205), aggregating user activity metrics into the single bucket with matching attributes (206), adding the most significant user name and its activity metrics into each bucket (208), and recording bucket contents (210). Once these human-consumable high-frequency (e.g., greater than one second) metrics are recorded, they are available for micro-trend analysis.

Further, the method includes determining a normal baseline for each bucket metric at block 408. For example, 15 consecutive minutes comprising high-frequency intervals are analyzed to determine a normal baseline for each bucket metric (e.g., mean). Because the buckets are user attribute (e.g., priority and size) based, the bucket baseline represents the baseline of all users in each bucket. Then for every bucket metric, an analyst can identify baseline deviation periods (e.g., one or more consecutive intervals deviating by at least a standardized threshold such as 10% above or below the normal baseline) called micro-trends as shown in block 410. In a bucket, a single user or multiple users behaving differently than the others can cause a micro-trend for the bucket. For every micro-trend (baseline deviation period), the analyst locates a single point peak or valley in block 412 and correlates peaks and valleys across micro-trends in block 414. Peak and valley micro-trend correlation locates other micro-trends experiencing peaks and valleys at the same time. For each micro-trend peak and valley, an analyst can identify workload interdependencies and interactions with cause and victim users being impacted at the time of the problem in block 416.

With micro-trends, a performance analyst can identify a set of users, workloads, and activities across the stack that are impacted during baseline deviation periods. With the impacted set of users, workloads, and activities, a performance analyst can focus on a deeper analysis of the impacted areas and ignore the unimpacted areas. Micro-trends improve the productivity of performance analysts greatly.

In one or more examples, the performance manager 116 may act based on micro-trends, such as allocating computer resources from the system 102 in a different manner to avoid anomalies for a single user or bucket of users. For example, subsequent similar workload requests from that user may receive additional computer resources, such as memory, processor time, and the like. For example, consider that the performance manager 116 generates data at a 5-second periodic interval. In some embodiments of the invention, the performance manager 116 detects each local bucket's exceptional user for a 5 second interval, and then acts upon that user to ‘spotlight’ that user for a subsequent 5 second interval.

The performance manager 116 may act using a micro-trend feedback loop to access the action taken. Micro-trends are detected at a higher level by performing an analysis against multiple 5-second periods. The micro-trend feedback loop occurs at the ‘broad view’ higher level analysis (i.e. longer interval), after a 5-second point has been determined to be an anomaly. At this point additional ‘spotlight’ actions may be taken beyond those described herein. As noted elsewhere herein, there can be at least two forms of exceptionalism: 1) worst offender for a bucket within a 5-second point; 2) anomalous highest peak 5-second point (micro-trend) across multiple 5-second points.

In other examples, when resource use for a single user or a bucket of users has micro-trends deviating from the baseline, the performance manager 116 can request the system 102 to allocate the resources in a different manner, particularly for users 150 identified to cause the anomaly in performance.

Accordingly, human-consumable high-frequency (e.g., greater than one second) data generation of micro-trends that include context-rich and concise activity metrics (e.g., requests, response times) over multiple intervals exhibit patterns, which in turn can be used to identify workload performance problem(s) and particularly, as described above, specific user attributes, specific workloads, or specific activities and resources impacting and/or contributing to a performance problem. Micro-trends are baseline deviation periods. For each micro-trend, activity metric peaks and valleys focus performance analysts on which components, activities, and resources are significant factors in the ailing workload.

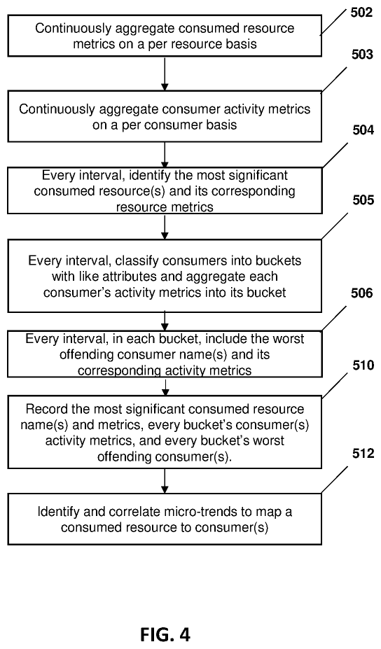

FIG. 4 illustrates an example method to use micro-trends to determine the consumed resource (e.g., which specific resource and what were its consumption metrics) and the consumer (e.g., which user 150 and what were its activity metrics) causing baseline deviations. The embodiment thus far requires instrumenting every consumed resource for every consumer (e.g., [consumed resources] *[consumers]). For many consumed resources (e.g., 100) and many consumers (e.g., 600), every consumed resource to consumer combination (e.g., 100*600=60,000) would have to be instrumented. This approach does not scale well for many consumed resources and many consumers. Instrumenting every consumed resource and consumer combination incurs high CPU and memory costs to collect, aggregate, and record the data. Furthermore, an analyst experiences data overload from analyzing a large data set of every consumed resource to consumer combination (e.g., 100*600=60,000). An analyst must find needles in a haystack because few combinations are of interest.

FIG. 4 depicts a flowchart for an example method for collecting metrics, generating data, and transforming data into micro-trends that reveal consumed resources to consumer relationships according to one or more embodiments of the present invention. The consumed resource-to-consumer combination of interest can be found quickly and more easily with smarter data collection and drawing conclusions from the collected data. First, continuously aggregate consumed resource metrics on a per resource basis (e.g., 100 consumed resource metrics) as shown in block 502. For example, after using a resource, aggregate the consumed resource metrics on a per resource basis. Next, continuously aggregate consumer activity metrics on a per consumer basis (e.g., 600 consumer activity metrics), as shown in block 503. For example, after using any resource (e.g., any of the 100 resources), aggregate the consumer activity metrics into the current consumer's activity metrics. Accordingly, one or more embodiments of the present invention facilitate providing smarter data collection that instruments significantly fewer resource activity metrics (e.g., 100+600=700 resource activity metrics which is significantly less than 100*600=60,000) and uses less CPU and memory than existing technologies.

In accordance with FIG. 4, at the end of every interval (e.g., greater than 1 second), identify the most significant consumed resource(s) and its corresponding resource metrics as shown in block 504. For example, one resource metric (e.g., largest aggregate time a resource was held) can determine the most significant consumed resource. Then, at the end of every interval, also classify consumers into buckets with like attributes, and for each consumer, increment the count of consumers and aggregate the consumer's activity metrics into its bucket as shown in block 505. This results in each bucket containing the aggregate consumer activity metrics for all activity across all consumers in each bucket. While aggregating consumer activity every interval, also include the worst offending consumer name(s) and its corresponding activity in each bucket, as shown in block 506. Similarly, one consumer activity metric (e.g., largest aggregate time a consumer held resources) can determine the worst offending consumer. Next, as shown in block 510, record the most significant consumed resource name(s) and metrics (results from block 504), every bucket's consumer activity metrics (results from block 505), and every bucket's worst offending consumer(s) and its corresponding activity metrics (results from block 506). Accordingly, one or more embodiments of the present invention significantly condense the data recorded. This embodiment condenses the consumed resources significantly by only recording the most significant consumed resource(s) (e.g., only 1 out of 100 resource activity metrics are recorded). Furthermore, this embodiment condenses consumer resources significantly by recording fewer consumer activity instances per bucket, such as bucket aggregate consumer activity and worst offending consumer(s) activity (e.g., for 16 buckets, only 32 consumer activity metrics are recorded). Further yet, the present invention focuses on recording summary data (bucket aggregate consumer(s) activity) and exceptional data (most significant consumed resource(s) and worst offending consumer(s)). In addition, non-exceptional consumed resources are condensed and summarized into totals and averages.

Furthermore, exceptional consumer activity entries are condensed and summarized into buckets as totals, averages, and worst-offending consumer(s) with corresponding activity metrics. These design points reduce noise and ensure concise and context-rich data, which lowers the CPU, memory, and storage costs.

Further, in conjunction, the method includes identifying and correlating micro-trends to map a consumed resource to consumer(s) at block 512 using techniques described herein (FIG. 3). The method further includes, for the most significant consumed resource(s): determining a normal baseline via block 408, identifying baseline deviation periods called micro-trends via block 410, and determining the peak or valley for every deviation period via block 412. This method further includes reapplying the same procedure (e.g., block 408, 410, and 412) to the bucket aggregate consumer and worst offending consumer(s). Next, correlate consumed resource peaks to consumer activity peaks to map a consumed resource to a consumer. In many cases, a consumed resource peak is correlated with a bucket aggregate consumer peak which is correlated with a worst offending consumer peak. In many cases, the worst offending consumer is causing the bucket aggregate consumer peak and the consumed resource peak. Using this invention, an analyst can use micro-trend correlation to map causing consumers with one or more affected consumed resources. Accordingly, one or more embodiments of the present invention facilitate adding both the most significant consumed resource and worst offending consumer to the data generation for micro-trend. Such data generation enables micro-trends to identify the specific consumed resource and specific consumer deviating from the baseline at significantly lower compute and analysis costs.

Accordingly, one or more embodiments of the present invention are rooted in computing technology, particularly defining a workload performance problem in a computing system where a consumed resource to consumer combination is a significant contributor to the problem. One or more embodiments of the present invention further improve existing solutions in this regard by improving performance and by reducing CPU cost (CPU usage), amount of data instrumented, stored, and further analyzed. In turn, the workload performance problem can be diagnosed faster compared to existing solutions.

One or more embodiments of the present invention provide such advantages through micro-trend correlation that maps consumed resource peaks to worst offending consumer activity peaks to reveal which resources are being heavily used and which consumers are driving the usage. The worst offending consumer can be a bucket (e.g., a collection of consumers) or the single worst offending consumer in the bucket. Now, a performance analyst has first failure data capture that can detect transient differences in consumed resource use and worst offending consumers between baseline and baseline deviation periods. In this manner, the performance analyst receives the right data to discover consumed resources to consumer relationships and at significantly lower costs to CPU, memory, and disk.

With every component in the system 102 recording the results as noted above, any component across the hardware or software stack can generate context-rich and concise data and use micro-trends to facilitate finding the consumed resource to consumer relationships across the stack.

Accordingly, one or more embodiments of the present invention facilitate time-synchronized, high-frequency, cross-stack data generation required to create micro-trends. Micro-trends facilitate an analyst to quickly investigate component data to identify normal and anomalous activity and determine the workload context, in turn significantly decreasing the time required to define a performance problem.

Smarter data generation facilitates detecting ripple effects in component performance by facilitating the determination of the component baseline and uncovering baseline deviations called micro-trends. Micro-trends reveal never before seen component ripple effects. Micro-trends emerge from generating context-rich, low overhead, and concise component activity records on a human-consumable, high-frequency, synchronized interval (e.g., greater than one second). Smarter data generation yields key component vital signs that enable establishing the component's normal baseline and identifying baseline deviation periods called micro-trends (e.g., one or more sequential high-frequency intervals deviating 10% above or below the baseline). Every micro-trend contains a peak or valley representing the interval deviating most from the baseline. Micro-trend peak and valley correlations reveal cause-and-effect ripples across components and resources. Micro-trends make subtle component ripple effects for transient durations (e.g., seconds) detectable.

Further, low overheads in accumulating and collecting the metrics used for micro-trend data generation facilitate generating synchronized always-on cross-stack micro-trends that capture the arrival pattern effects on the workload context. Always-on micro-trends cast a wide net to catch ripple effects across the entire workload. They ensure performance first failure data capture is available whenever a performance problem is detected.

Micro-trends lower the expertise needed to detect and diagnose performance impacts. With micro-trends, performance teams can detect cause-and-effect relationships between workload components. Micro-trends improve triage and define areas of focus by exonerating unaffected components and resources, implicating the affected components and resources, and engaging the right experts.

Further, system availability improves with micro-trends. Micro-trends provide insights into problem areas before the problem causes outages. Experts can recommend configuration and/or tuning changes so that the system operation can be stabilized and the workload performance problem mitigated. An analyst can use micro-trends to assess whether an implemented configuration and/or tuning change had the intended effect without unintended consequences.

Further, micro-trends further improve solution quality because they provide a continuous feedback loop. For example, development teams can use micro-trends to make better design decisions and receive timely feedback by measuring the impacts within and across components. Development teams can foster performance improving conditions and avoid performance degrading conditions. Further yet, test teams can use micro-trends to validate that an intended scenario was driven and measure the desired results were achieved. Micro-trends also improve automation. As described herein, systems can automatically tune or configure a computer server, or an operating system, based on micro-trends. Further yet, in one or more examples, the system or an analyst can use micro-trends to assess whether a configuration change was a step in the right direction to commit or a step in the wrong direction to undo.

Further, one or more embodiments of the present invention facilitate generating smarter data input to reduce the cost and improve the speed of machine learning. Machine learning builds a model that represents input training data. Building a model requires cleansing and evaluating the training data to consider the relevant data and ignore the noise. Then, the resulting model scores input test data that has a mixture of normal and anomalous data. Comparing the model results with the expected test data results produces a model accuracy percent. With micro-trend data generation changes, higher frequency machine-consumable, fine-grained micro-trends can reduce machine learning training and scoring costs while maintaining model accuracy. One or more embodiments of the present invention, accordingly, provide a practical application for generating micro-trend diagnostic data that can be used to build a machine learning model which can score traditional mainline data or other micro-trend diagnostic data.

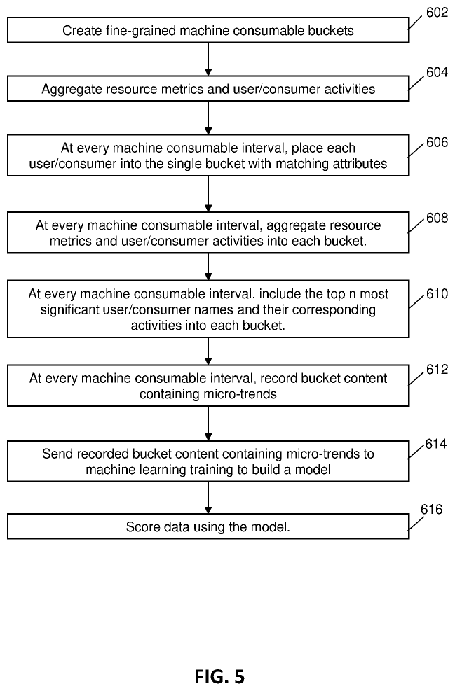

FIG. 5 depicts a flowchart for an example method to generate micro-trend data for machine learning. First, in block 602, the method creates fine-grained machine-consumable buckets, which contain more buckets than human-consumable micro-trend data generation. Next, in block 604, aggregate resource metrics like block 502 and user/consumer activities like blocks 202 and 503. Then in block 606, for every machine-consumable interval (e.g., less than one second, which is not human-consumable), each user/consumer is placed into a single bucket with matching attributes like 205 and 505. It should be noted that machine-consumable interval and human-consumable interval can be substantially different because of the rate at which humans can analyze the data compared to a machine (e.g., computer). It should be noted that the machine-consumable interval is a higher frequency interval compared to a human-consumable interval. Next, in block 608, on every machine-consumable interval, resource metrics and user/consumer activity metrics are aggregated into buckets like blocks 206 and 505. Then in block 610, on every machine-consumable interval, the top n most significant user/consumer names and their corresponding activities are included in each bucket. Then, in block 612, on every machine-consumable interval, bucket content containing micro-trends is recorded like blocks 210 and 510. Next, bucket content containing micro-trends is sent to machine learning training to build a model in block 614. Then data is scored using the model as shown in block 616. Scoring can be done against machine-consumable buckets containing micro-trends or traditional mainline data.

The machine-consumable micro-trend data generation for machine learning builds on top of human-consumable micro-trend data generation. Both generate synchronized, structured, context-rich data at an acceptable CPU cost. Human-consumable micro-trend data generation has to avoid overwhelming or tiring the analyst, but that is not a concern for machine-consumable micro-trend data generation. As a result, machine-consumable micro-trend data generation collects additional buckets via new/additional bucket attributes (e.g., new z/OS job sizes of extra-large and extra-small) that distributes the workload across more buckets and yields fewer users/consumers in each bucket. Furthermore, with machine-consumable micro-trend data generation, each bucket includes its non-exceptional users/consumers in the summary activity and captures its exceptional activity, such as the top n most significant users/consumers. Also, machine-consumable micro-trend data generation occurs more frequently than human-consumable micro-trend data generation. Machine learning requires higher frequency and fine-grained micro-trend data generation to build a representative model while maintaining model accuracy.

The cost-effectiveness and speed of machine learning training improve with machine-consumable micro-trend data generation. Machine-consumable micro-trend data generation produces synchronized, structured, context-rich data that contains both summary and exceptional activity. Machine-consumable micro-trend data generation reduces and refines the data to keep important summaries and exceptional content and removes noise. This content enables machine learning training to choose from only the most valuable data. Machine learning training using machine-consumable micro-trend data input has significantly fewer data to evaluate, which results in fewer model iterations to differentiate important data from noise. As a result, machine-consumable micro-trends deliver lower data generation and model training costs while maintaining model accuracy.

Machine learning scoring also benefits from machine-consumable micro-trend data generation. Machine-consumable micro-trend data generation enables a new form of scoring that can be done regularly during the higher frequency machine-consumable interval. Micro-trend summary context enables scoring to better assess whether test data is normal or anomalous based on the summary and exceptional activity. Furthermore, all machine learning scoring benefits from micro-trend data generation correlations between workload component interactions and consumer to consumed resource cause and victim peers.

Smarter data generation can significantly improve machine learning training. By reconfiguring human-consumable micro-trend data generation into machine-consumable micro-trend data generation, machine learning training can improve model building cost and speed while maintaining model accuracy. Generating machine-consumable micro-trends requires a large number of fine-grained buckets, the top n most significant users/consumers, and more frequent data generation (e.g., less than one second).

According to one or more embodiments, a computer-implemented method for diagnosing workload performance problems in computer servers includes measuring activity metrics and aggregating lower-level activity metrics into higher-level user constructs for each user. The method further includes generating condensed diagnostic data for identifying workload performance problems on a synchronized, regular interval. Generating diagnostic data includes grouping users into buckets based on the bucket and user attributes, aggregating user activity metrics across all users in each bucket, including one or more most significant user(s) and corresponding user activity metrics for each activity in each bucket, and recording bucket contents. The method includes generating high-level, condensed diagnostic data at a human-consumable analysis interval and analyzing recorded bucket contents to facilitate determining a baseline and baseline deviation periods, identifying a peak or valley for every baseline deviation, and correlating peaks and valleys temporally to identify cause and victim interdependencies and relationships between buckets, most significant users, and activities. This method also includes generating high-level, condensed diagnostic data at the machine-consumable interval to train a machine learning model with lower data generation and model training costs while maintaining model accuracy. The resulting model can be used to score new condensed diagnostic data or traditional mainline data. In one or more examples, the method further includes analyzing bucket contents at an analysis interval to identify buckets and users synchronously deviating from normal.

According to one or more embodiments, a computer program product includes a memory device with computer-executable instructions therein, the instructions, when executed by a processing unit, perform a method of diagnosing workload performance problems in computer servers. The method includes measuring activity metrics and aggregating lower-level activity metrics into higher-level user constructs for each user. The method further includes generating condensed diagnostic data for identifying workload performance problems on a synchronized, regular interval. Generating diagnostic data includes grouping users into buckets based on the bucket and user attributes, aggregating user activity metrics across all users in each bucket, including one or more most significant user(s) and corresponding user activity metrics for each activity in each bucket, and recording bucket contents. The method includes generating high-level, condensed diagnostic data at a human-consumable analysis interval. Further, the method includes analyzing recorded bucket contents to facilitate determining baseline and baseline deviation periods, identifying a peak or valley for every baseline deviation, and correlating the peaks and valleys temporally to identify cause and victim interdependencies and relationships between buckets; the most significant users, and activities. This method also includes generating high-level, condensed diagnostic data at the machine-consumable interval to train a machine learning model with lower data generation and model training costs while maintaining model accuracy. The resulting model can be used to score new condensed diagnostic data or traditional mainline data. In one or more examples, the method further includes analyzing bucket contents at an analysis interval to identify buckets and users synchronously deviating from normal.

According to one or more embodiments, a system includes a memory and a processor coupled to the memory; the processor performs a method of diagnosing workload performance problems in the system. The method includes measuring activity metrics and aggregating lower-level activity metrics into higher-level user constructs for each user. The method further includes generating condensed diagnostic data for identifying workload performance problems on a synchronized, regular interval. Generating diagnostic data includes grouping users into buckets based on the bucket and user attributes, aggregating user activity metrics across all users in each bucket, including one or more most significant user(s) and corresponding user activity metrics for each activity in each bucket, and recording bucket contents. The method includes generating high-level, condensed diagnostic data at a human-consumable analysis interval and analyzing recorded bucket contents to determine a baseline and baseline deviation periods, identify a peak or valley for every baseline deviation and correlate peaks and valleys temporally to identify cause and victim interdependencies and relationships between buckets, most significant users, and activities. This method also includes generating high-level, condensed diagnostic data at the machine-consumable interval to train a machine learning model with lower data generation and model training costs while maintaining model accuracy. The resulting model can be used to score new condensed diagnostic data or traditional mainline data. In one or more examples, the method further includes analyzing bucket contents at an analysis interval to identify buckets and users synchronously deviating from normal.

In one or more embodiments, diagnostic data can be generated in a human-consumable form for human analysis or in a machine-consumable form for machine analysis through machine learning.

Embodiments of the present invention use the aggregated data to further improve anomaly detection. For example, the data collection/aggregation can implicitly group the data, for example, by data set name, source, consumer, etc., alternatively, or in addition, the data may be aggregated using data set activity and access methods (extending “cube” of priority/size/cp-type).

Embodiments of the present invention can further perform anomaly detection based on data that has been aggregated over multiple activities per group. For example, data set “access patterns” are aggregated by group (e.g., #bytes read, #bytes written, capture jobs with the most activity, etc.). Such aggregation enables each group created to represent a logical “view” of data set activity. Embodiments of the present invention facilitate reducing the volumes of instrumentation data by aggregating at the group level.

Further, yet, in one or more embodiments of the present invention, analytics are embedded in the data generation itself. Exceptional activity in group, for each activity, is then hyper-correlated to the data sets being accessed by one or more consumers. Embodiments of the present invention can provide inline data correlation. Additionally, the embedding of the analytics during data generation itself optimizes the anomaly detection process by eliminating the need to track each resource (every address space, every data set operation, every consumer, etc.). It should be noted that, without such embedded analytics, the number of factors that the anomaly detection demands to be monitored is a product of the number of each resource (e.g., X producers*Y consumers). With embodiments of the present invention, only the exceptional job details can be tracked.

In some embodiments of the present invention, a historical reference database (metric library 130) is used to capture enriched behavioral signatures. The signatures can be analyzed using heuristic, algorithmic, and statistical modeling to determine anomalous activity.

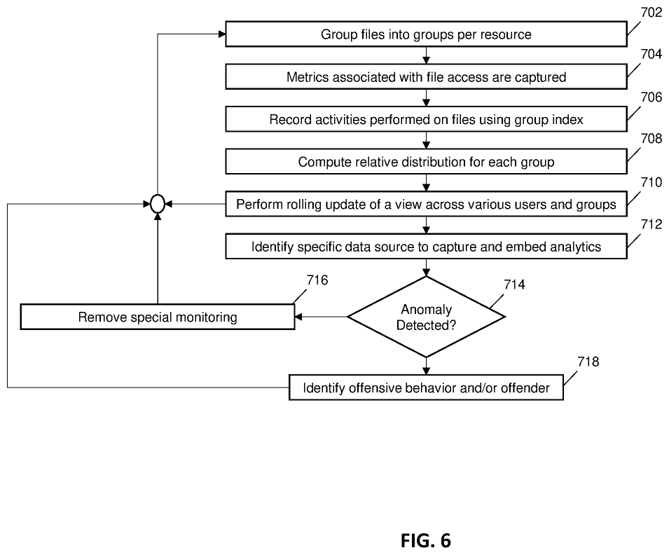

FIG. 6 depicts a flowchart of a method for anomaly detection according to one or more embodiments of the present invention. Here, data intrusion detection in an operating system (e.g., Z/OS®) is used as an example to describe the method 700. However, it is understood that the method 700 can also be applied in other scenarios for anomaly detection. Particularly, in the method 700, detecting an inconsistent pattern of file access (inconsistent with historical behavior) in Z/OS® is used as an example of anomaly detection. Note that files (also referred to as Z/OS® data sets) are an unbounded list of resources.

Anomaly detection in data access patterns includes identifying a resource 750, such as a digital asset (e.g., file, folder, data in a database, financial information, login credential, electronic medical record, images/video, etc.) and an offender (person/people and/or machine(s) being used) accessing the resource in an atypical/unusual manner. For optimal anomaly detection, both, the resource and the offender have to be identified. Existing techniques for anomaly detection are based on analyzing all permutations of users 745 and resources 750 (X users*Y resources). Hence, the existing techniques do not scale (i.e., are not cost effective) to environments such as mainframes (e.g., Z/OS® based systems), where the number of users and the number of resources 750 are both high (in millions). Technical solutions described herein address such technical challenges by embedding analytics into the data generation.

For example, the method 700 facilitates summarizing data into substantive ‘micro-averages’ for collections of resources, at a frequent standardized periodicity. While calculating these activity averages (e.g., read/write operations) at every period (e.g., 5 seconds, 10 seconds etc.), the groups are enriched by identifying the single worst offender for each key activity, within each collection, and in every period. Further, the embedded analytics data generation is then extended, such that an offender identified during a period TO are spotlighted in a next period (e.g., period T1), to only generate data for the identified offender (e.g., track the files accessed by identified offender). Accordingly, offending users 745 and the resources 750 (e.g., digital assets) that are offended are identified every two periods in time (T0 and T1 in above example). Above technique can be referred to as ‘local’ subsequent data generation actions based upon an earlier period's data.

Such high frequency summary data is generated for several consecutive periods (e.g., T0-Tn, where n is an integer). In some aspects, the high frequency summary is captured continuously, and a predetermined number of most recent time periods are subsequently consumed/analyzed by a near-time Inspector, and most recent offender values are compared to historical norms, to determine if they are anomalous over time. Once an Activity is identified as anomalous, this ‘broad view’ anomaly indicator is fed back into subsequent data generation, to enable even more data to be generated for this anomalous, exceptional offender (particular user only). Accordingly, subsequently the analytics necessary and used to accurately identify anomalous behavior by the Inspector are significantly reduced because of the data embedded for particular users at generation itself.

The method 700 is now described with file intrusion detection in a mainframe environment (e.g., Z/OS®) as an example, although the hyper-correlate-based data embedding and generating techniques described herein can be used to a wide range of computer-based and other applications.

At block 702, the files are grouped into resource groups (e.g., 64 resource groups). For example, a resource group can be based on a disk on which the files are physically stored. Alternatively, or in addition, the resource group can be based on file permissions (e.g., read-access, write-access, etc.). Any other parameters associated with the files can be used for grouping the files into resource groups. In some cases, the number of resource groups is predetermined. In other applications, other resources 750 (instead of files) are grouped. For example, in an autonomous vehicle environment, vehicles, and/or sensors from which metrics are being captured are grouped.

At block 704, the access to the files is monitored, and metrics associated with the access are captured. When a consumer (in this case, an address space) accesses a resource (in this case, acts on a file), metrics for the resource are generated and stored. In some embodiments of the present invention, the metrics are stored by hashing on resource name (i.e., data set name/filename). It is understood that other types of classification can be used instead of hashing in other embodiments of the present invention. In case of other applications, the metrics associated with access of the other resources 750 are captured.

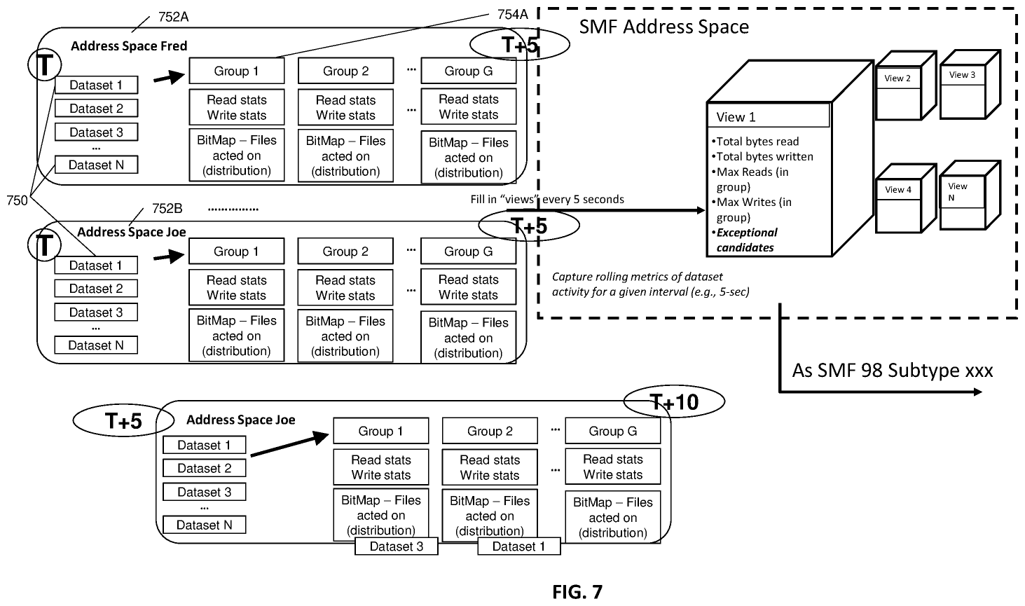

FIG. 7 is a depiction of anomaly detection in an example scenario of data set (i.e., file) access according to one or more embodiments of the present invention. In the example, multiple data sets 750 (resources) are shown to be accessed by separate users 752—Fred 752A and Joe 752B (consumers). The users 752 are represented as address spaces. FIG. 7 depicts timepoints at which events occur, such as a data set 750 being accessed by T<suffix>, where a suffix is a number that indicates chronological order. Although “seconds” is used as a unit of time in this example, it is understood that in other examples, the time can be measured in different units, for example, microseconds, minutes, etc.

Consider that at time T, Fred 752A accesses a data set, say data set1, from the data set 750. Also, at time T, Joe 752B accesses a data set (same or different from Fred 752A). Each access is hashed into a respective group corresponding to the data set that is accessed, i.e., metrics associated with the access are routed to be recorded into the respective group.

Split hash value into resource group index and semi-unique identifier. The semi-unique identifier precision is based on the number of bytes allocated for the semi-unique identifier. For instance, a 1-byte identifier taken as part of the hash value allows a 1-1 correspondence to a 256-bit bitmap (as a 1-byte field can capture 256 states), and a high-quality hash will uniformly distribute across those 256 bits. This bitmap can then be used to estimate how many data sets are accessed within a bucket by a job or a user within a predetermined frequency, as the value of the identifier can be mapped to a bit that is logically ORed with the rest of the bits in the bitmap. At the end of the predetermined frequency interval, the bitmap can be queried to see the distribution of data sets accessed within the interval.

At block 706, the group index is used to record “activities” performed on the resources (data sets 750) by the consumers (users 752) at the group level. For example, in the example scenario of FIG. 7, the data set access activity can cause metrics associated with the data set access to be stored in the corresponding group associated with the data set that is accessed. The metrics associated with data set access can include read statistics (time at which data set read, amount of time data set accessed, which portion of data set accessed, etc.), and write statistics (time at which data set written into, amount of data written into, portion written into, etc.). Other types of data set access metrics can be recorded in other embodiments of the present invention, as described herein. For example, in an autonomous vehicle environment, sensor measurements of different vehicles are captured and analyzed.

At block 708, a relative distribution is computed for each group to represent how that resource group is being used by the consumer (e.g., consumer writing to a particular file in the group or to all files). The relative distribution can be stored as a bitmap in one or more embodiments of the present invention.

The operations depicted in blocks 702 to 708 are continuously performed at a predetermined frequency, for example, every 10 seconds interval, 20 seconds interval, etc.

At block 710, the metrics captured during each data collection interval are used to update a view 760. The aggregation can be performed at a different frequency than the time interval at which the grouping is performed (702 to 708). For example, an interval may be of 5 seconds, and the aggregation of the data captured during each interval may be performed every 20 seconds. It is understood that the interval and aggregation period can be of different durations from the above examples.

The view 760 aggregates several metrics across the various users 752 and the groups 754. For example, the view 760 can aggregate metrics such as total bytes read, total bytes written, maximum reads (in a group), maximum writes (in a group), and exceptional candidates in the file intrusion scenario. Techniques described herein can be used to compute such aggregation and identify exceptional (i.e., offending) candidates. (see FIG. 4). In this manner, users 752 that are potentially offending the resource groups 754 can be identified. In some scenarios, such as cyber security, predictability can be disadvantageous and a technical challenge. Accordingly, technical solutions herein address such challenges by facilitating two separate time periods, one or both of which can be dynamically adjusted. In some aspects, the time periods are stochastically updated so that the predictability is reduced. For example, the capture of metrics (702-to-708) can be performed at time intervals of varying duration, i.e., TO of 5 seconds, T1 of 7 seconds, T3 of 4 seconds, etc. Alternatively, or in addition, the aggregation (710) can be performed at varying frequency, e.g., every 10 seconds, every 15 seconds, every 12 seconds, etc. In some aspects, Only the security data producers and an inspector consuming the security data, are aware of the actual periodicity. Accordingly, a potential offender can find it challenging to manipulate the data.

At block 712, specific data sources are identified to capture and embed analytics. For example, for those users 752 that are identified as potentially offending one or more resource groups, the system can note exceptionalism and track individual data set access in the group on the next time interval (for as long as exceptionalism is noted). In the ongoing example scenario, where the time interval was T to T+5, the next time interval was T+5 to T+10. Tracking individual exceptionalism includes embedding analytics at the source of the data in one or more embodiments of the present invention. Alternatively, or in addition, for a resource 750 (e.g., digital asset) that is identified as being potentially offended, the system can note exceptionalism and track data associated with that resource 750 only. For example, access information of a file, sensor information of a vehicle, or of a component, etc.

For example, in the example of FIG. 7, if Joe 752B was identified as the potentially offending user and further as accessing data set 1 and/or data set 3, in the next time interval (T=5 to T+10), only the metrics associated with Joe's 752B access of data set 1 and data set 3 are captured and aggregated. Further, metrics associated with Joe's 752B access to data set 1 and data set 3 can be embellished with additional metrics that are not captured for other user's (e.g., Fred's) access of data set 1 and/or data set 3. Alternatively, or in addition, metrics associated with Joe's 752B access of data set 1 and data set 3 can be embellished with additional metrics that are not captured for Joe's 752B access of other data sets (e.g., data set 2).

In this manner, only a specific set of metrics can be accumulated and analyzed for detecting anomalies rather than monitoring each activity being performed. Additionally, certain metrics can be additionally captured only for the identified potential anomaly. It should be noted that the specific set of metrics captured for the exceptionalism identified (offender/offended) (at block 712) are in addition to the continuous capture, grouping, and aggregation of metrics performed (blocks 702-to-708).

The specific metrics captured for detecting anomalies (block 712) are analyzed to determine if an anomalous behavior exists at block 714. Several techniques can be used to detect an anomaly in the captured data.

In some embodiments of the present invention, an entropy calculation can be used to detect the anomaly in the data. In an entropy-based approach, “chunks,” “windows,” or portions of input data are analyzed.

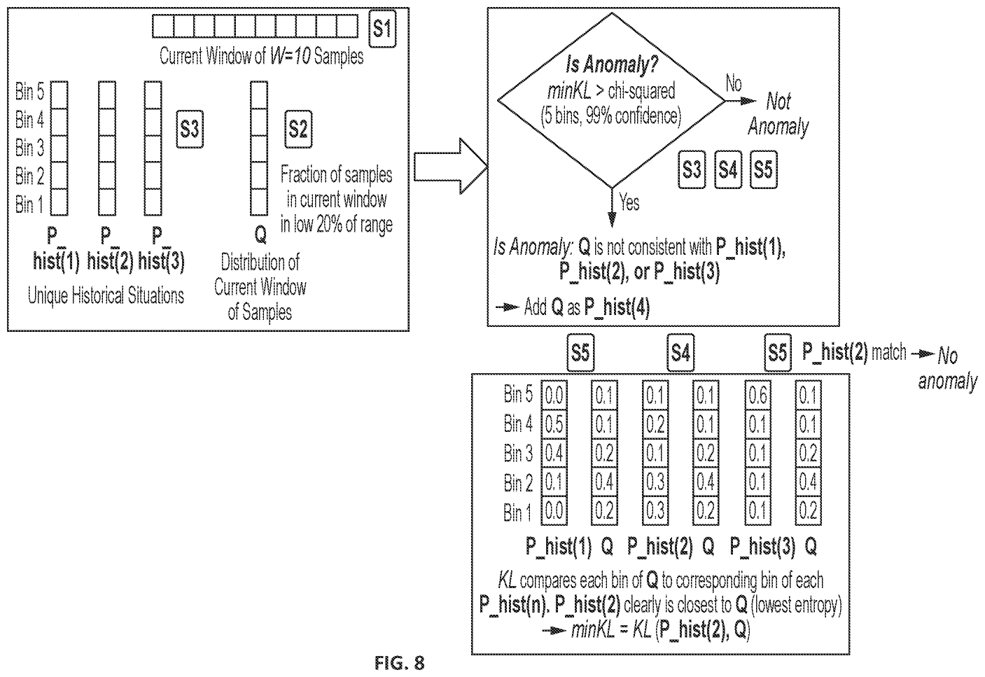

FIG. 8 provides a visual depiction of an entropy-based anomaly detection example. In step-S1, the input data is sampled into N windows, each window W=10 samples. In step-S2, it is noted what fraction of the ten samples has a value in each of the N bins, e.g., N=5 here. Historical distributions of window values are compared to bins at step-S3 if the value of a bin is close to some historical distribution→No anomaly is deemed at step-S4; alternatively, if the value is significantly different→Anomaly+New Historical Distribution, it is deemed, at step-S5, here, the difference can be based on a predetermined value.

In the entropy-based approach, the number of unique historical distributions required, P_hist, is empirically small, e.g., ten over 100,000 samples. Performing the anomaly detection in this manner has an overhead, which is linear in the number of variables. The entropy-based anomaly detection can be implemented using machine learning with unsupervised learning online and continuously. Such an approach can be used for a stream of values for a single variable. Embodiments of the present invention can improve the entropy-based approach in several ways. For example, using the methods herein, anomalies can be detected across multiple variables, and that too in linear time. The anomalies can be detected in both individual variables and correlations between variables. Embodiments of the present invention further facilitate dynamic range for each variable. Further, a unified, seamless approach for missing variables can be used. In some embodiments of the present invention, spectral frequency analysis can also be performed based on entropy-based anomaly detection.

While an entropy-based anomaly detection is described, it is understood that in one or more embodiments of the present invention, any other anomaly detection algorithm can be used to analyze the data that is specifically generated for identified data sources. For example, Mahalanobis distances after dimension reduction, autoencoders, spectral density calculation, determining a deviation from the mean, or any other such anomaly detection algorithms can be used, which are not described in detail here.

In one or more embodiments of the present invention, at block 716, if the specific aggregated data is no longer indicative of the symptoms for categorizing the user 752 and/or the resource 750 as an outlier (offending), the specific metrics for the identified potential offending user (e.g., Joe 752B) is no longer monitored. Alternatively, or in addition, in one or more embodiments of the present invention, at block 718, if the specific aggregated data continues to be indicative that the user 752 and/or the resource 750 is an outlier (offending) for more than a predetermined duration (e.g., number of time intervals), the user 752B is identified as an offender. In this case, notifications are sent to specific personnel to identify a potential breach and/or anomalous activity so that an alert response can be performed. In some cases, the operating system may be shut down and/or reconfigured to a more protected mode to prevent further anomalous activity. Alternatively, or in addition, the offending user (e.g., Joe 752B) may be prohibited from accessing any content by the operating system in one or more embodiments of the present invention.

While data set access is used as an example to describe anomaly detection, it is understood that one or more embodiments of the present invention can be used for other types of anomaly detection. For example, embodiments of the present invention can facilitate building/generating behavioral signatures from data over a long duration (e.g., days). Such behavioral signatures can be dynamically detected based on the reoccurrence of signatures. Embodiments of the present invention can also be used to build a historical reference database for proactive analysis. Further, one or more embodiments of the present invention can facilitate creating new algorithms to recognize exceptional intrusion detection activity in near-real-time. In some embodiments of the present invention, continuous learning can be performed from the client environment over time.

In one or more embodiments, detecting anomalies in computing systems includes measuring activity metrics associated with access of the resources (e.g., digital assets), the resources being accessed by several users. The lower-level activity metrics are aggregated into higher-level user constructs for each resource. Further, condensed diagnostic data is generated. The condensed diagnostic data can be generated on a synchronized, regular interval. Alternatively the condensed diagnostic data is generated using a dynamic time interval. Generating the condensed diagnostic data includes grouping the resources into buckets based on bucket and resource attributes. The activity metrics are aggregated across all resources in each bucket, and from the aggregated data, one or more most significant (i.e., exceptional) resources and corresponding activity metrics are identified for each activity in each bucket.

For example, In addition to generating condensed diagnostic data, buckets are used to identify exceptional users for each bucket. ‘Spotlights’ are put on the exceptional users for these buckets, by acting upon them to capture their non-aggregated resource usage at the next time interval. The continuous aggregation of activity metrics for the next time interval, defines the exceptional user spotlights for the subsequent time interval, and so on. For example, in the context of the file access, a particular file experiencing an anomalous access can be ‘spotlighted.’ Alternatively, a user that accesses files anomalously can be ‘spotlighted.’ Once, identified in this manner, the extra activity metrics for the spotlighted item can be captured, which can include file-pointers identifying location within the file that was accessed, time-of-day at which the file was accessed, IP address or other identification related information associated with the file access, etc.

Embodiments of the present invention facilitate identifying file access patterns as exception data intrusion candidates based on the file access significantly deviating from typical file accesses, as described herein. On-platform (i.e., data does not leave the operating system). In one or more embodiments of the present invention, when an offender is detected (718), an alert is generated. For example, when the number of times a particular user is detected exhibiting a certain anomalous behavior (e.g., anomalous file access) above a threshold (predetermined or learned), an alert can be generated. In some embodiments of the present invention, the offending user is prevented from further access to the system until s/he is reauthorized for such access.

One or more embodiments of the present invention facilitate using a computing device to detect anomalous activity in computer server environments having multiple customers. For example, a computer-implemented method can include determining by the computing device one or more highest accessed resources accessed by each customer in the computer server environment. Further, the method includes tracking by the computing device one or more most frequent activities in the highest accessed resources of the computer server environment. Further, the method includes determining by the computing device one or more offending customers of the plurality of customers based upon the highest accessed resources and the one or more most frequent activities in the highest accessed resources. Further, the method includes detecting all anomalous activity associated with one or more offending customers accessing any resource associated with the computer server environment over a period of time.

One or more embodiments of the present invention improve anomaly detection by curating the quality of the input data that is used to detect anomalies. Further, in addition to filtering data that is being generated to improve the input data that is analyzed for detecting anomalies, embodiments of the present invention facilitate embellishing the data being generated for specific data sources that are identified as potential offenders. Such embellishing can include certain embedding analytics in the data generated and captured for the potential offenders.

It should be noted that the technical solutions described herein are not limited to detecting anomalies in computer server, mainframes, and anomalous file access patterns. The technical solutions herein are applicable in any technical area in which data streams are generated and analyzed. For example, autonomous vehicle decision making uses concentrated high-value data to cost effectively analyze a large number of variables (hundreds, thousands) to determine an action to be taken by the autonomous vehicle. For example, whether the vehicle can change a lane, turn left, accelerate, etc.

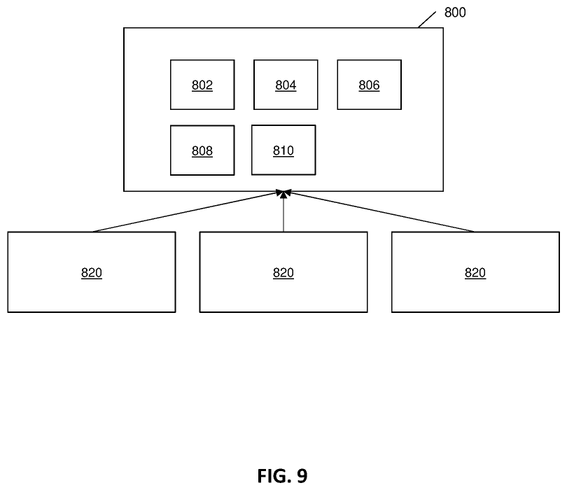

FIG. 9 depicts one or more embodiments of the present invention. A data consumer 800 and several data generators 820 are shown. As noted elsewhere, one or more embodiments of the present invention are applicable in several technical fields where the data consumer 800 analyzes a large number of data streams from data generators 820 and/or self-generated, and makes one or more decisions based on the analysis. For example, consider an autonomous vehicle decision making process. An autonomous vehicle 800 (“vehicle”) is shown as the data consumer (800) including one or more components. It is understood that the vehicle 800 can include several other components that are not shown. The vehicle 100 includes one or more processors 802 (“processors”), a communication module 804, a memory device 806, one or more sensors 808 (“sensors”), and one or more actuators 810, among other components. The processors 802 process several streams of data, for example, using machine learning, computer vision, etc. The processors 802 can use the memory device 806 when analyzing the data streams. For example, the memory device 806 can include one or more instructions and other ancillary data to facilitate the analysis.

The one or more data streams can be received by the processors 802 from other vehicles, computer servers (e.g., weather service, traffic service, navigation service, etc.). All of these sources of data stream can be the data generators 820. The data streams can be received via the communication module 804. In some examples, the data streams can also include measurements captured by the sensors 808. The sensors 808 can include lidars, radars, pressure sensors, etc. The data streams can include information that has to be analyzed by the processors 802 to determine one or more actions to be performed by the vehicle 800. The processors 802 send one or more commands to the actuators 808 to perform the actions based on the decision making process.

During such decision making, the processors 802 may have to analyze a large number of data streams, some (or most) of which may include low-value detail data resulting in an increased processor costs to both generate and analyze that data. Another critical cost is the bandwidth necessary for the vehicles 800 to communicate both among each other and any centralized agent, such as a central controller server (not shown). Using embodiments of the technical solutions described herein, hyper-correlate techniques are used to generate both “micro-averages” and detailed data only for locally detected “exceptional” conditions by the processors 802 of the vehicle 800. Accordingly, significantly reduced compute resources can be used for the decision making analytics. The data concentration also significantly reduces the communication costs/delays associated with sharing the data. Accordingly, embodiments of the present invention facilitate building accurate sensor technology into mainline path operations being performed, to effectively share the data analysis responsibilities between the data producers, and the analytics engines (e.g., machine learning models). Based on the analysis, in one or more examples, the central agent, or a peer (e.g., another vehicle) can request additional information be generated as part of a feedback provided to the data generator. The costs saved by not producing and consuming data using technical solutions herein facilitate to cost effectively perform timely decision making, which is critical to the success of delivering autonomous vehicle decision making, and other such critical applications.

Several other IoT based and cloud-computing based applications can use the technical solutions described herein, for example, factory automation, warehouse automation, air traffic control, etc. FIG. 9 is applicable to any of these applications, where 800 depicts a data consumer (800) that is making decisions based on several data streams from data generators 820 that are analyzed by the data consumer 800 for a decision making process. The processors 802 can use the techniques described herein to adjust the data generation of the data stream for future time intervals to improve the quality of the data that is being produced, and in turn, improving the efficiency of the data analysis.

Embodiments of the present invention provide improvements to computing technology, particularly in the areas of anomalous behavior detection. Further, one or more embodiments of the present invention provide a practical application for detecting anomalies and identifying an offender.

One or more embodiments of the present invention provide such improvements and practical applications by facilitating the dynamic generation of exceptionalism-enriched data streams for instrumentation and forensic analysis. Instead of capturing per-event operating system call information and trying to filter the captured information to reduce noise and meet NRT (Near Real-Time) detection requirements, one or more embodiments of the present invention build intelligence into the data generation phase within the operating system itself. Such improved data generation facilitates collecting only relevant key activities and user/resource/process information that relates to exceptional resource usage within a compute environment. Accordingly, one or more embodiments of the present invention facilitate intelligent data generation in the operating system. The dynamic data (instrumentation) generation automatically learns what resources to track in a system based on exceptional access to those resources. Accordingly, embodiments of the present invention can be used for host data intrusion detection systems but also for optimization of information-technology (IT) systems (e.g., lock contention or high file I/O causing low performance, etc.).

One or more embodiments of the present invention use a mapping (e.g., hashing) scheme coupled with outlier analysis. Embodiments of the present invention enable precise problem determination (e.g., intrusion, low performance, correlation across distributed environments) and perform such determination with low overhead.

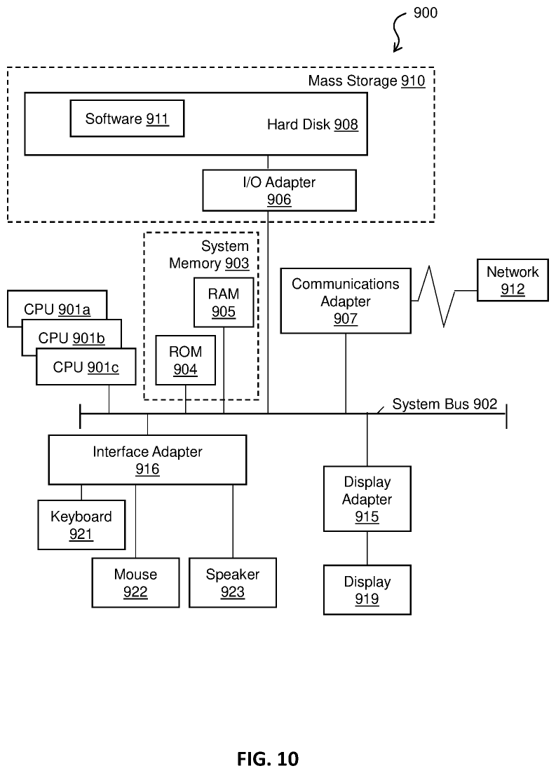

Turning now to FIG. 10, a computer system 900 is generally shown in accordance with an embodiment of the present invention. The computer system 900 can facilitate detecting anomalous activity in computer servers. In one or more embodiments of the present invention, the computer system 900 is the computer server itself for which the anomalous behavior is detected. In one or more embodiments of the present invention, the computer system 900 is separate from the computer server for which the anomalies are detected. The computer system 900 can be an electronic computer framework comprising and/or employing any number and combination of computing devices and networks utilizing various communication technologies, as described herein. The computer system 900 can be easily scalable, extensible, and modular, with the ability to change to different services or reconfigure some features independently of others. The computer system 900 may be, for example, a server, desktop computer, laptop computer, tablet computer, or smartphone. In some examples, computer system 900 may be a cloud computing node. Computer system 900 may be described in the general context of computer system executable instructions, such as program modules, being executed by a computer system. Generally, program modules may include routines, programs, objects, components, logic, data structures, and so on that perform particular tasks or implement particular abstract data types. Computer system 900 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 10, the computer system 900 has one or more central processing units (CPU(s)) 901a, 901b, 901c, etc. (collectively or generically referred to as processor(s) 901). The processor 901 can be a single-core processor, multi-core processor, computing cluster, or any number of other configurations. The processors 901, also referred to as processing circuits, are coupled via a system bus 902 to system memory 903 and various other components. The system memory 903 can include a read-only memory (ROM) 904 and a random access memory (RAM) 905. The ROM 904 is coupled to the system bus 902 and may include a basic input/output system (BIOS), which controls certain basic functions of the computer system 900. The RAM is read-write memory coupled to the system bus 902 for use by the processors 901. The system memory 903 provides temporary memory space for operations of said instructions during operation. The system memory 903 can include random access memory (RAM), read-only memory, flash memory, or any other suitable memory systems.

The computer system 900 comprises an input/output (I/O) adapter 906 and a communications adapter 907 coupled to the system bus 902. The I/O adapter 906 may be a small computer system interface (SCSI) adapter that communicates with a hard disk 908 and/or any other similar component. The I/O adapter 906 and the hard disk 908 are collectively referred to herein as a mass storage 910.

Software 911 for execution on the computer system 900 may be stored in the mass storage 910. The mass storage 910 is an example of a tangible storage medium readable by the processors 901, where the software 911 is stored as instructions for execution by the processors 901 to cause the computer system 900 to operate, such as is described hereinbelow with respect to the various Figures. Examples of computer program product and the execution of such instruction is discussed herein in more detail. The communications adapter 907 interconnects the system bus 902 with a network 912, which may be an outside network, enabling the computer system 900 to communicate with other such systems. In one embodiment, a portion of the system memory 903 and the mass storage 910 collectively store an operating system, which may be any appropriate operating system, such as the z/OS or AIX operating system from IBM Corporation, to coordinate the functions of the various components shown in FIG. 10.

Additional input/output devices are shown as connected to the system bus 902 via a display adapter 915 and an interface adapter 916 and. In one embodiment, the adapters 906, 907, 915, and 916 may be connected to one or more I/O buses that are connected to the system bus 902 via an intermediate bus bridge (not shown). A display 919 (e.g., a screen or a display monitor) is connected to the system bus 902 by a display adapter 915, which may include a graphics controller to improve the performance of graphics intensive applications and a video controller. A keyboard 921, a mouse 922, a speaker 923, etc. can be interconnected to the system bus 902 via the interface adapter 916, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 10, the computer system 900 includes processing capability in the form of the processors 901, and, storage capability including the system memory 903 and the mass storage 910, input means such as the keyboard 921 and the mouse 922, and output capability including the speaker 923 and the display 919.

In some embodiments, the communications adapter 907 can transmit data using any suitable interface or protocol, such as the internet small computer system interface, among others. The network 912 may be a cellular network, a radio network, a wide area network (WAN), a local area network (LAN), or the Internet, among others. An external computing device may connect to the computer system 900 through the network 912. In some examples, an external computing device may be an external webserver or a cloud computing node.

It is to be understood that the block diagram of FIG. 10 is not intended to indicate that the computer system 900 is to include all of the components shown in FIG. 10. Rather, the computer system 900 can include any appropriate fewer or additional components not illustrated in FIG. 10 (e.g., additional memory components, embedded controllers, modules, additional network interfaces, etc.). Further, the embodiments described herein with respect to computer system 900 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

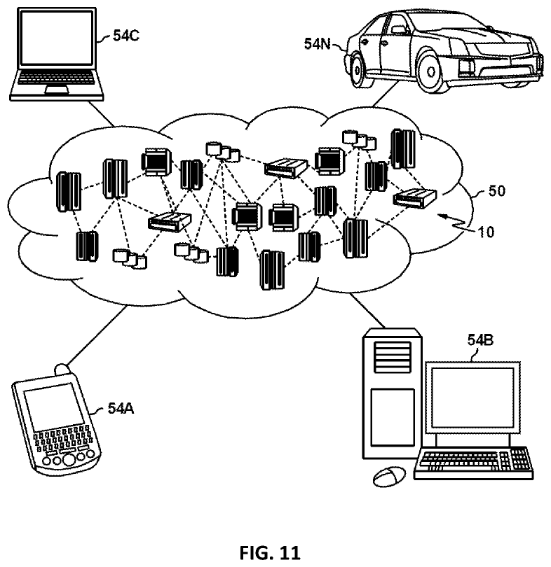

Referring now to FIG. 11, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

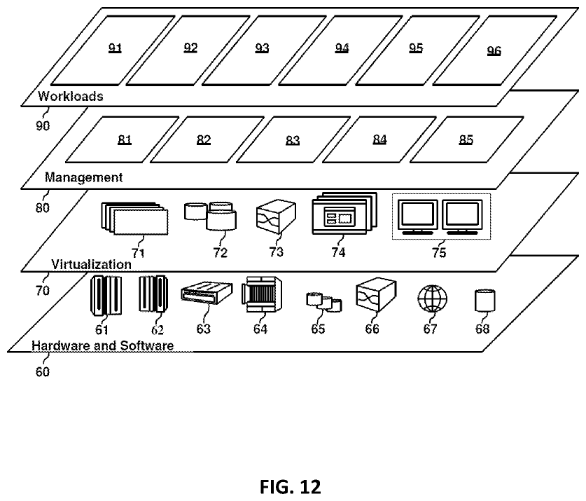

Referring now to FIG. 12, a set of functional abstraction layers provided by cloud computing environment 50 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data generation 96.

The present invention can be a system, a method, and/or a computer program product at any possible technical detail level of integration. The computer program product can include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting anomalies in computing systems, the method comprising:
measuring activity metrics associated with access of a plurality of resources of a computing system, the resources being accessed by a plurality of users;
aggregating lower-level activity metrics into higher-level user constructs for each user; and
generating condensed diagnostic data for the computing system, wherein generating the condensed diagnostic data comprises:
grouping the users into a plurality of buckets based on bucket and user attributes;
aggregating the activity metrics across all users in each bucket;
recording bucket contents; and
generating analytic embedded data for anomaly detection, the generating comprising:
for each of the plurality of buckets, capturing the activity metrics for an exceptional user in each bucket without aggregation at a next time interval.

2. The computer-implemented method of claim 1, wherein measuring activity metrics, aggregating lower-level activity metrics higher-level user constructs for each user, and generating the condensed diagnostic data on a synchronized, regular interval are always-on and continuously collected.

3. The computer implemented method of claim 1, wherein one or more bucket attributes are based on user attribute ranges related to the activity metrics where the users belonging to each bucket are within a unique bucket range.

4. The computer-implemented method of claim 1, wherein one or more bucket attributes are from a standardized set of user attributes independent of the activity metrics where the users belonging to each bucket have matching attributes.

5. The computer-implemented method of claim 1, wherein the activity metric comprises at least one from a group comprising a usage time, an access count, a response time, and a delay time.

6. The computer-implemented method of claim 1, wherein each bucket includes a count of the number of users and one or more most significant users is determined by one from a group of the largest aggregate usage time, the largest aggregate access count, the largest aggregate response time, and the largest aggregate delay time.

7. The computer-implemented method of claim 1, wherein the condensed diagnostic data that is generated comprises a predetermined number of buckets, and a predetermined analysis interval, and wherein the computer-implemented method further comprises:
determining the baseline for every metric in each bucket;
determining baseline deviation periods by a standardized threshold for every metric in each bucket;
identifying a peak for every baseline deviation period above the baseline and a valley for every baseline deviation period below the baseline for every metric in each bucket; and
exploiting workload-wide, synchronized, high-level, condensed diagnostic data to enable correlating peaks and valleys temporally to identify cause and victim interdependencies and relationships between buckets, most significant users, and activities.

8. The computer-implemented method of claim 1, wherein the condensed diagnostic data generated is machine-consumable comprising a predetermined number of buckets, and a predetermined analysis interval, and wherein the computer-implemented method further comprises:
building a machine learning model with the condensed diagnostic data; and
scoring condensed diagnostic data or traditional mainline data with the machine learning model.

9. The computer-implemented method of claim 1, wherein the activity metrics associated with access of a plurality of resources comprise metrics associated with file access.

10. The computer-implemented method of claim 1, wherein measuring activity metrics, aggregating lower-level activity metrics higher-level user constructs for each user, and generating the condensed diagnostic data are performed at randomized frequencies.

11. A computer program product comprising a memory device with computer-executable instructions therein, the instructions when executed by a processing unit perform a method comprising:
measuring activity metrics associated with access of a plurality of resources of a computing system, the resources being accessed by a plurality of users;
aggregating lower-level activity metrics into higher-level user constructs for each user; and
generating condensed diagnostic data for the computing system on a synchronized, regular interval, wherein generating the condensed diagnostic data comprises:
grouping the users into a plurality of buckets based on bucket and user attributes;
aggregating the activity metrics across all users in each bucket;
including one or more most significant users and corresponding activity metrics for each activity in each bucket; and
recording bucket contents;
generating analytic embedded data for anomaly detection, the generating comprising:
for each of the plurality of buckets, capturing the activity metrics for an exceptional user from each bucket without aggregation at a next time interval.

12. The computer program product of claim 11, wherein measuring activity metrics, aggregating lower-level activity metrics into higher-level user constructs for each user, and generating the condensed diagnostic data on the synchronized, regular interval are always-on and continuously collected.

13. The computer program product of claim 11, wherein one or more bucket attributes are based on user attribute ranges related to activity metrics where the users belonging to each bucket are within a unique bucket range.

14. The computer program product of claim 11, wherein the activity metric comprises at least one from a group comprising a usage time, an access count, a response time, and a delay time.

15. The computer program product of claim 11, wherein each bucket includes a count of the number of users and one or more most significant users is determined by one from a group of the largest aggregate usage time, the largest aggregate access count, the largest aggregate response time, and the largest aggregate delay time.

16. The computer program product of claim 11, wherein the condensed diagnostic data that is generated comprises a predetermined number of buckets, and a predetermined analysis interval, and wherein the computer-implemented method further comprises:
determining a baseline for every metric in each bucket;
determining baseline deviation periods by a standardized threshold for every metric in each bucket;
identifying a peak for every baseline deviation period above the baseline and a valley for every baseline deviation period below the baseline for every metric in each bucket; and
exploiting workload-wide, synchronized, high-level, condensed diagnostic data to enable correlating peaks and valleys temporally to identify cause and victim interdependencies and relationships between buckets, most significant users, and activities.

17. The computer program product of claim 11, wherein the condensed diagnostic data generated is machine-consumable comprising a predetermined number of buckets, and a predetermined analysis interval, and wherein the computer-implemented method further comprises:
building a machine learning model with the condensed diagnostic data; and
scoring condensed diagnostic data or traditional mainline data with the machine learning model.

18. The computer program product of claim 11, wherein the activity metrics associated with access of a plurality of resources comprise metrics associated with file access.

19. The computer program product of claim 11, wherein the activity metrics associated with access of a plurality of resources comprise metrics associated with accessing computing resources comprising processor, memory, and network.

20. A system comprising:
a memory; and
one or more processing units coupled to the memory, the one or more processing units configured to perform a method comprising:
measuring activity metrics associated with access of a plurality of resources of a computing system, the resources being accessed by a plurality of users;
aggregating lower-level activity metrics into higher-level user constructs for each user; and
generating condensed diagnostic data for the computing system on a synchronized, regular interval, wherein generating the condensed diagnostic data comprises:
grouping the users into a plurality of buckets based on bucket and user attributes;
aggregating the activity metrics across all users in each bucket;
including one or more most significant users and corresponding activity metrics for each activity in each bucket; and
recording bucket contents;
generating analytic embedded data for anomaly detection, the generating comprising:
for each bucket from the plurality of buckets, capturing the activity metrics for an exceptional user from each bucket without aggregation at a next time interval.
